(19) United States
(12) Patent Application Publication
(10) Pub. No.: US 2017/0329485 A1
(43) Pub. Date: Nov. 16, 2017

(54) Tap Touch Code

(71) Applicant: Macphonia Jones, Margate, FL (US)

(72) Inventor: Macphonia Jones, Margate, FL (US)

(21) Appl. No.: 15/436,992

(22) Filed: Mar. 20, 2017

Related U.S. Application Data
(63) Continuation of application No. 62/315,168, filed on Mar. 30, 2016.

(51) Int. Cl. G06F 3/0488; G06F 21/30; G06F 3/0354

(52) U.S. Cl. CPC G06F 3/0488; G06F 3/03547; G06F 21/30

(57) ABSTRACT

My invention idea called “The Tap Touch Code”. You basically think of any melody in your head. You don't have to think of numbers, letters, or symbols; just a melody. Tap this melody in your phone three times. Your phone gauges the rhythm of how you tap your melody. It remembers it, and that becomes your password. This method takes the stress of remembering all those different passwords out of the equation. Just tap in your melody and you're in.

My invention idea called “The Tap Touch Code”. The specification/operating idea is that you tap a specific pattern on your cellular screen to unlock your phone, rather than typing letters, symbols and/or numbers to unlock your phone. It's like a secret door knock for a person to recognize you at the door before letting you in.

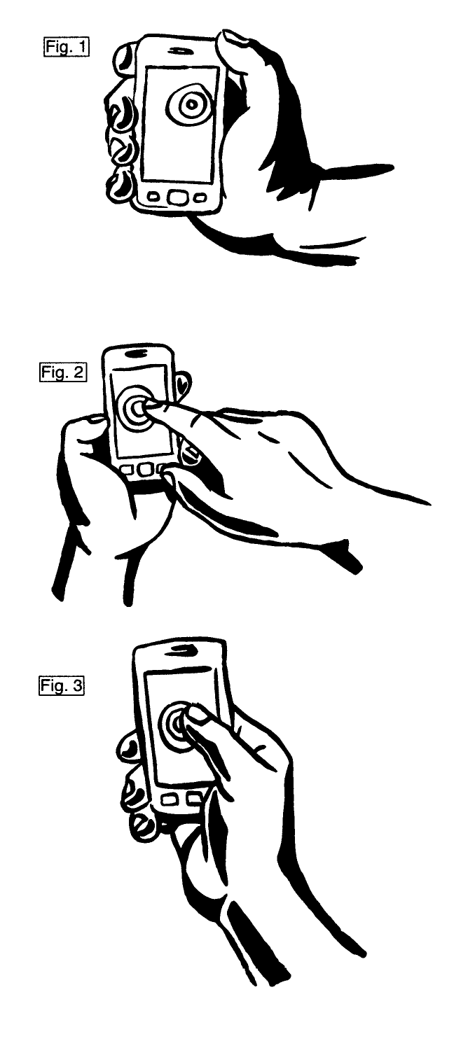

FIG. 1. Your phone asks you to record a specific tapping pattern three times anywhere on the screen.

FIG. 2. It recognizes the pattern and gauges the timing of all of the recordings.

FIG. 3. It becomes your pass code to unlock your phone.

### BENEFITS

1. You don't have to worry about remembering all those numbers, letters, & symbols again.
2. Makes it easier for people to remember a melody, rather than a complicated old-school-way-password.
3. Makes it easier for the visually impaired to tap a melody w/o having to type in a password in a specific area on their phone.
4. Makes it easier for people with memory issues to tap in a melody they LOVE.
5. This NEW method will generate more cellular purchases across the world because this will be a fun, new, & easy way of operating your phone/device.

1. I claim this idea to be invented by me and me alone. It was derived from observing people getting frustrated when they forgot their passwords. Furthermore, some people I knew said they'd have to reset their passwords every other month because they had to remember so many of them. One night, sitting on the couch in my house, it came to me; take the use of numbers, symbols, & letters out of equation all together and replace it with remembering a simple melody you like. I researched it heavily and found that no one had come up with this idea. In fact, as simple as it was, no one thought to patent it. So I filed for a patent.
I want my Non-Provisional patent to be granted, in the hope that I can help millions upon millions of people, and make life just a smidge easier. After all, sometimes the easiest solutions are over-looked.
